(19) United States
(12) Patent Application Publication
(10) Pub. No.: US 2019/0287452 A1
(43) Pub. Date: Sep. 19, 2019

(54) ACTIVE-MATRIX ORGANIC LIGHT-EMITTING DIODE PIXEL CIRCUIT OF INTEGRATED EXTERNAL PROCESSOR AND DRIVING METHOD FOR THE SAME

(71) Applicants: Interface Technology (ChengDu) Co., Ltd., Chengdu City (CN); Interface Optoelectronics (ShenZhen) Co., Ltd., Shenzhen City (CN); General Interface Solution Limited, Zhunan Township (TW)

(72) Inventor: Guan Jiun WANG, Zhunan Township (TW)

(21) Appl. No.: 15/949,508

(22) Filed: Apr. 10, 2018

(30) Foreign Application Priority Data
Mar. 15, 2018 (CN) 201810213979.9

(51) Int. Cl. G09G 3/325

(52) U.S. Cl. CPC G09G 3/325; G09G 2320/045; G09G 2320/0693; G09G 2310/061; G09G 2310/0251

(57) ABSTRACT

An active-matrix organic light-emitting diode pixel circuit and a driving method for the same are provided to eliminate adverse effects of variation in transistor threshold voltage. However, owing to internal parasitic parameters of transistors, compensation for variation in a threshold voltage is not necessarily fully achieved. Therefore, mura otherwise arising from variation in a threshold voltage and degradation of organic light-emitting diodes is eliminated at an emission stage by an external processor's sensing an anode voltage of the organic light-emitting diodes, calculating an offset value related thereto, and adjusting an originally output data voltage with the offset value.

### CROSS REFERENCE

This non-provisional application claims priority from China Patent Application No. 201810213979.9 filed on Mar. 15, 2018, the content thereof is incorporated by reference herein.

### BACKGROUND OF THE INVENTION

### Field of the Invention

The present invention relates to the field of display panels and, more particularly, to an active-matrix organic light-emitting diode pixel circuit of an integrated external processor, and the active-matrix organic light-emitting diode pixel circuit reduces mura otherwise arising from degradation of organic light-emitting diodes (OLEDs) or variation in a threshold voltage.

### Description of the Prior Art

Subject to requirements of a thin-film transistor (TFT) process carried out at a high temperature and in a pressurized environment for a long period of time, conventional active-matrix organic light-emitting diodes (AMOLEDs) thus manufactured have a disadvantage, that is, a drift of threshold voltage (Vth). Non-uniformity in a threshold voltage of thin-film transistors arranged throughout a display panel occurs, because the amount of threshold voltage drift of the thin-film transistors varies from display frame to display frame. The non-uniformity in the threshold voltage translates into the organic light-emitting diode (OLED) display device's current differences and brightness differences which are eventually perceived as mura by the human eyes. Pixel circuits in conventional organic light-emitting diode panels are not designed to compensate for a threshold voltage drift; as a result, mura occurs to the display frames. Therefore, the conventional process entails improving the pixel circuit framework to compensate for the threshold voltage drift with a view to eliminating mura.

As time goes by, research and development of an internal pixel compensation circuit framework has hit a bottleneck, and thus the researchers and developers are no longer making any practical breakthroughs. Furthermore, compensation for the threshold voltage cannot be fully achieved because of driving speed and parasitic parameters of thin-film transistors; hence, the odds are that electric currents will be inconsistent in case of excessive deviation.

### SUMMARY OF THE INVENTION

It is an objective of the present invention to provide an active-matrix organic light-emitting diode pixel circuit of an integrated external processor with a view to eliminating, at an initialization stage, residual voltage that remains in a circuit during a preceding driving period and reducing, by the external processor, mura otherwise arising from degradation of organic light-emitting diodes (OLEDs) or variation in a threshold voltage.

In order to achieve the above and other objectives, the present invention provides an active-matrix organic light-emitting diode pixel circuit of an integrated external processor, comprising: an organic light-emitting diode, a first capacitor, a light emission starting unit, a driving unit, a data input unit, a compensation unit, an initialization unit, and a sensing starting unit. The organic light-emitting diode is coupled to a first reference voltage to receive a driving current so as to emit light. The first capacitor has a first end and a second end, with the first end coupled to a second reference voltage. The light emission starting unit is coupled to the organic light-emitting diode, the first end of the first capacitor, and the second reference voltage to cause the driving current to go to the organic light-emitting diode according to a light emission starting signal. The driving unit is coupled to the light emission starting unit to generate and output the driving current, wherein the driving unit has a first end, a second end, and a control end. The data input unit is coupled to the first end of the driving unit and the light emission starting unit to supply a data voltage according to a first scan signal. The compensation unit is coupled to the second end of the first capacitor, the first end and the control end of the driving unit, the light emission starting unit, and the data input unit to compensate for a threshold voltage of the driving unit according to a second scan signal and the data voltage. The initialization unit is coupled to the control end and the second end of the driving unit and the compensation unit to reset the driving unit according to a fixed voltage and a third scan signal and cause the compensation unit to store the threshold voltage. The sensing starting unit is coupled to the organic light-emitting diode and an external processor to sense an anode voltage of the organic light-emitting diode according to a sensing signal, transmit the anode voltage to an external processor, cause the external processor to calculate an offset value of the data voltage according to the anode voltage, and refresh the data voltage with the offset value.

The present invention also provides a driving method for an active-matrix organic light-emitting diode pixel circuit of an integrated external processor, adapted to drive the active-matrix organic light-emitting diode pixel circuit of an integrated external processor of claim 1, the driving method comprising the steps of: (a) driving the initialization unit with the third scan signal in a first period to cause the initialization unit to reset the driving unit according to the fixed voltage, eliminate residual voltage of the driving unit, and form diode connection together with the driving unit, thereby causing the compensation unit to store a threshold voltage. (b) driving the data input unit with the first scan signal in a second period following the first period to supply a data voltage to the pixel circuit, charging a node between the first capacitor and the compensation unit under the data voltage with the second scan signal and causing the control end of the driving unit to achieve an intended compensated voltage level by the compensation unit; and. (c) driving the driving unit to output the driving current under a voltage at a second end of the second capacitor in a third period following the second period, driving the light emission starting unit with the light emission starting signal to feed the driving current to the organic light-emitting diode so as for the organic light-emitting diode to emit light, triggering with the sensing signal the sensing starting unit to sense an anode voltage of the organic light-emitting diode, transmitting a sensing voltage to the external processor without affecting the driving current, and allowing the external processor to calculate an offset value of the data voltage according to the anode voltage, refresh the data voltage with the offset value, store the refreshed data voltage in the storage unit and at an address therein associated with a corresponding grayscale value, and output the compensated data voltage to the pixel circuit in the next instance of displaying the corresponding grayscale to effectuate compensation.

### BRIEF DESCRIPTION OF THE DRAWINGS

FIG. 1 is a schematic view of the unit framework of an active-matrix organic light-emitting diode pixel circuit of an integrated external processor according to a preferred embodiment of the present invention;

FIG. 2 is a schematic view of the circuit framework of the active-matrix organic light-emitting diode pixel circuit of an integrated external processor according to the preferred embodiment of the present invention;

FIG. 3 is a timing diagram of control-related signals of the active-matrix organic light-emitting diode pixel circuit of an integrated external processor according to the preferred embodiment of the present invention;

FIG. 4 is a schematic view of the process flow of a driving method for the active-matrix organic light-emitting diode pixel circuit of an integrated external processor according to the preferred embodiment of the present invention;

FIG. 5 is a schematic view of a look-up table of “anode voltage - data voltage” relationship demonstrated by an external compensation computational unit of the active-matrix organic light-emitting diode pixel circuit of an integrated external processor according to the preferred embodiment of the present invention; and

FIG. 6 is a schematic view of how compensated data voltages correlate with grayscale values in a storage unit of the active-matrix organic light-emitting diode pixel circuit of an integrated external processor according to the preferred embodiment of the present invention.

### DETAILED DESCRIPTION OF THE EMBODIMENTS

Features and functions of the technical means and structures applied to the present invention to achieve the aforesaid objectives and effects are depicted by drawings, illustrated with preferred embodiments, and described below so as to be fully comprehensible but not restrictive of the present invention.

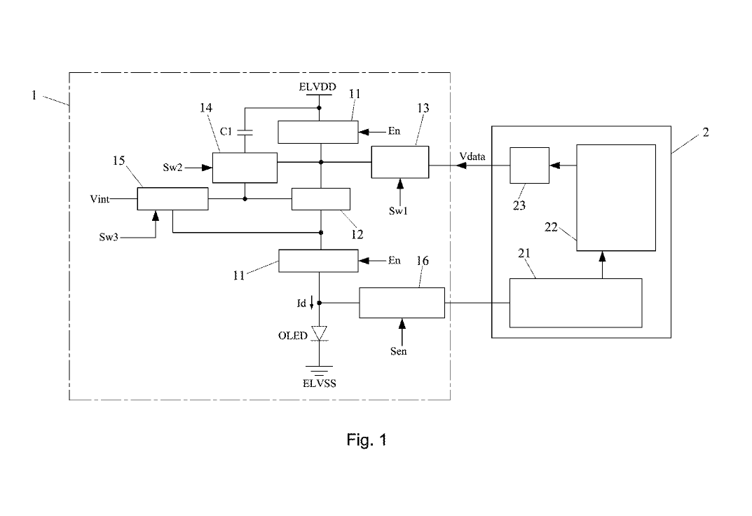

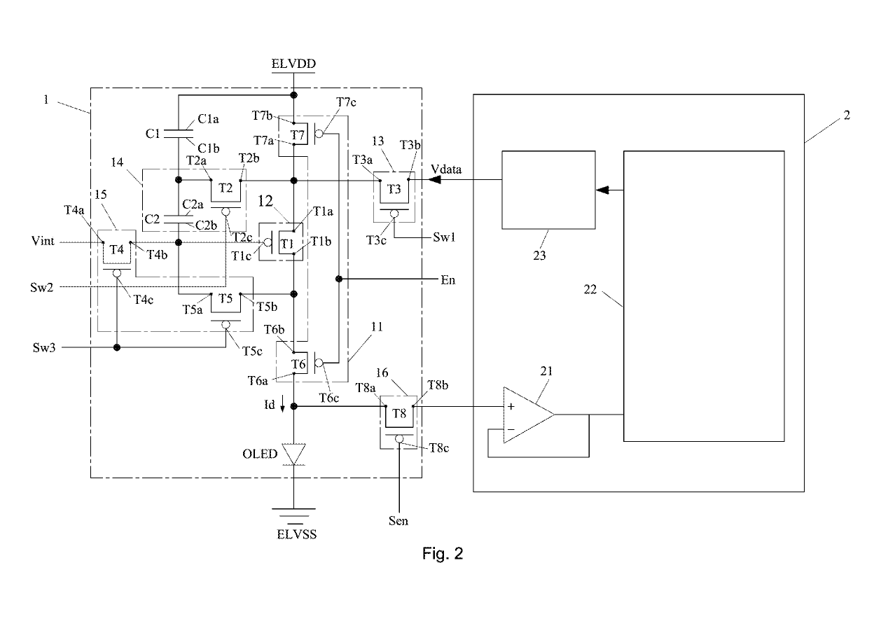

Referring to FIG. 1 and FIG. 2, there are shown schematic views of the unit framework and the circuit framework of an active-matrix organic light-emitting diode pixel circuit of an integrated external processor according to a preferred embodiment of the present invention, respectively. In the preferred embodiment of the present invention, the active-matrix organic light-emitting diode pixel circuit of an integrated external processor is applicable to an active-matrix organic light-emitting diode (AMOLED) display device which comprises a plurality of active-matrix organic light-emitting diode pixel circuits 1 (one of which is shown in FIG. 1). The pixel circuit 1 comprises an organic light-emitting diode OLED, a first capacitor C1, a light emission starting unit 11, a driving unit 12, a data input unit 13, a compensation unit 14, an initialization unit 15, and a sensing starting unit 16.

The OLED is coupled to a first reference voltage ELVSS to receive a driving current Id, so as to emit light.

The first capacitor C1 has a first end C1a and a second end C1b. The first end C1a is coupled to a second reference voltage ELVDD to stabilize the voltage at a node between the first capacitor C1 and the compensation unit 14.

The light emission starting unit 11 is coupled to the OLED, the first end C1a of the first capacitor C1, and the second reference voltage ELVDD to supply the driving current Id to the OLED according to a light emission starting signal En.

The driving unit 12 is coupled to the light emission starting unit 11 to output the driving current Id to the light emission starting unit 11. The driving unit 12 is a transistor and has a first end T1a, a second end T1b, and a control end T1c.

The data input unit 13 is coupled to the first end T1a of the driving unit 12 and the light emission starting unit 11 to supply a data voltage Vdata according to a first scan signal Sw1.

The compensation unit 14 is coupled to the second end C1b of the first capacitor C1, the first end T1a and the control end T1c of the driving unit 12, the light emission starting unit 11, and the data input unit 13 to compensate for a threshold voltage Vth (not shown) of the driving unit 12 according to a second scan signal Sw2 and the data voltage Vdata.

The initialization unit 15 is coupled to the control end T1c and the second end T1b of the driving unit 12 and the compensation unit 14 to reset the driving unit 12 according to a fixed voltage Vint and a third scan signal Sw3 and cause the compensation unit 14 to store the threshold voltage Vth.

The sensing starting unit 16 is coupled to the OLED and an external processor 2 to sense an anode voltage (not shown) of the OLED and transmit the anode voltage to the external processor 2. The external processor 2 calculates an offset value of the data voltage Vdata according to the anode voltage and comprises a voltage sensing unit 21, an external compensation computational unit 22, and a storage unit 23. The voltage sensing unit 21 is in telecommunication with the sensing starting unit 16 and essentially comprises buffers to transmit the sensed anode voltage to the external compensation computational unit 22 so as to effectuate computation, without affecting the light emission function of the light-emitting diode. The external compensation computational unit 22 is in telecommunication with the voltage sensing unit 21 to calculate an offset value of the data voltage Vdata according to the anode voltage and compensate for the data voltage Vdata with the offset value. The storage unit 23 is in electrical connection with the external compensation computational unit 22 and the data input unit 13 to store the compensated data voltage Vdata′ at an address associated with a corresponding grayscale value and output the compensated data voltage Vdata′ to the data input unit 13 in the next instance of displaying the corresponding grayscale.

FIG. 2 is a schematic view of the circuit framework of the active-matrix organic light-emitting diode pixel circuit of an integrated external processor according to the preferred embodiment of the present invention. As shown in FIG. 2, the driving unit 12 is a first transistor T1. The first end of the first transistor T1 is coupled to the light emission starting unit 11, the data input unit 13, and the compensation unit 14. The second end of the first transistor T1 is coupled to the light emission starting unit 11 and the initialization unit 15 and generates the driving current Id. The driving current passes through the light emission starting unit 11 and reaches the OLED. The control end of the first transistor T1 is coupled to the compensation unit 14 and the initialization unit 15.

The compensation unit 14 comprises a second capacitor C2 and a second transistor T2. The second capacitor C2 comprises a first end C2a and a second end C2b. The first end C2a is coupled to the second end C1b of the first capacitor C1. The second end C2b is coupled to the control end T1c of the driving unit 12 and the initialization unit 15. The first capacitor C1 stabilizes the voltage at a node of the second capacitor C2, thereby stabilizing the voltage at the control end T1c of the driving unit 12. The second transistor T2 has a first end T2a, a second end T2b, and a control end T2c. The first end T2a of the second transistor T2 is coupled to the second end C1b of the first capacitor C1. The second end T2b of the second transistor T2 is coupled to the first end T1a of the driving unit 12, the light emission starting unit 11, and the data input unit 13. The control end T2c of the second transistor T2 receives the second scan signal Sw2.

The data input unit 13 comprises a third transistor T3. The third transistor T3 has a first end T3a, a second end T3b, and a control end T3c. The first end T3a of the third transistor T3 is coupled to the first end T1a of the driving unit 12, the light emission starting unit 11, and the compensation unit 14 (the second end T2b of the second transistor T2) to output the data voltage Vdata. The second end T3b of the third transistor T3 is coupled to the storage unit 23 to receive the data voltage Vdata. The control end T3c of the third transistor T3 receives the first scan signal Sw1.

The initialization unit 15 comprises a fourth transistor T4 and a fifth transistor T5. The fourth transistor T4 has a first end T4a, a second end T4b, and a control end T4c. The first end T4a of the fourth transistor T4 receives the fixed voltage Vint. The second end T4b of the fourth transistor T4 is coupled to the compensation unit 14, the control end T1c of the driving unit 12, and the fifth transistor T5. The control end T4c of the fourth transistor T4 receives the third scan signal Sw3. The fifth transistor T5 has a first end T5a, a second end T5b, and a control end T5c. The first end T5a of the fifth transistor T5 is coupled to the second end T4b of the fourth transistor T4, the compensation unit 14, and the control end T1c of the driving unit 12. The second end T5b of the fifth transistor T5 is coupled to the light emission starting unit 11 and the second end T1b of the driving unit 12. The control end T5c of the fifth transistor T5 receives the third scan signal Sw3.

The light emission starting unit 11 comprises a sixth transistor T6 and a seventh transistor T7. The sixth transistor T6 has a first end T6a, a second end T6b, and a control end T6c. The first end T6a of the sixth transistor T6 is coupled to the OLED and the sensing starting unit 16 to supply the driving current Id to the OLED. The second end T6b of the sixth transistor T6 is coupled to the initialization unit 15 (the second end T5b of the fifth transistor T5) and the second end T1b of the driving unit 12. The control end T6c of the sixth transistor T6 receives the light emission starting signal En. The seventh transistor T7 has a first end T7a, a second end T7b, and a control end T7c. The first end T7a of the seventh transistor T7 is coupled to the compensation unit 14 (the second end T2b of the second transistor T2), the data input unit 13 (the first end T3a of the third transistor T3), and the first end T1a of the driving unit 12. The second end T7b of the seventh transistor T7 is coupled to the first end C1a of the first capacitor C1 and the second reference voltage ELVDD. The control end T7c of the seventh transistor T7 receives the light emission starting signal En.

The sensing starting unit 16 comprises an eighth transistor T8. The eighth transistor T8 has a first end T8a, a second end T8b, and a control end T8c. The first end T8a of the eighth transistor T8 is coupled to the OLED and the light emission starting unit 11 (the first end T6a of the sixth transistor T6). The second end T8b of the eighth transistor T8 is coupled to the external processor 2 (the voltage sensing unit 21). The control end T8c of the eighth transistor T8 receives the sensing signal Sen. In a internal pixel circuit of the present embodiment, the driving current Id passing through the OLED is only affected by the second reference voltage ELVDD and the data voltage Vdata; hence, a drift of the threshold voltage Vth does not affect its current changes and thus has already compensated for any variation in the threshold voltage Vth. However, owing to the process or parasitic parameters, compensation for variation in the threshold voltage Vth is not necessarily fully achieved. Therefore, in the preferred embodiment of the present invention, the external compensation data voltage Vdata reduces mura which might otherwise be caused by a drift of the threshold voltage Vth.

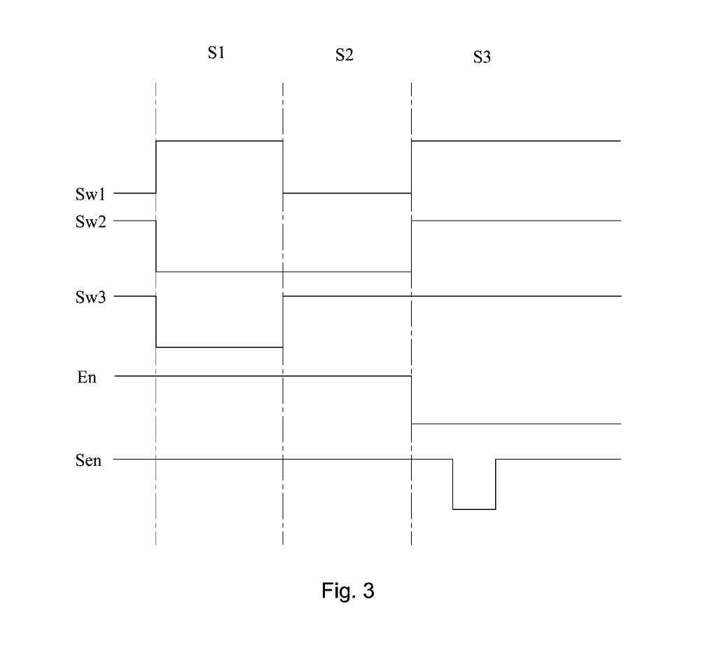

Referring to FIG. 3, there is shown a timing diagram of control-related signals of the active-matrix organic light-emitting diode pixel circuit of an integrated external processor according to the preferred embodiment of the present invention. As shown in the diagram, first scan signal Sw1, second scan signal Sw2, third scan signal Sw3, light emission starting signal En and sensing signal Sen are externally provided scan signals, and they are of high voltage levels or low voltage levels, depending on timing. The low voltage levels are deemed grounding (GND). If the signals are applied to the gate of the transistor to control the transistor, the low voltage levels will turn on the P-type transistor (PMOS), whereas the high voltage levels will turn on the N-type transistor (NMOS). Optionally, if the signals are of high voltage levels, the high voltage levels of the signals can turn off the P-type transistor.

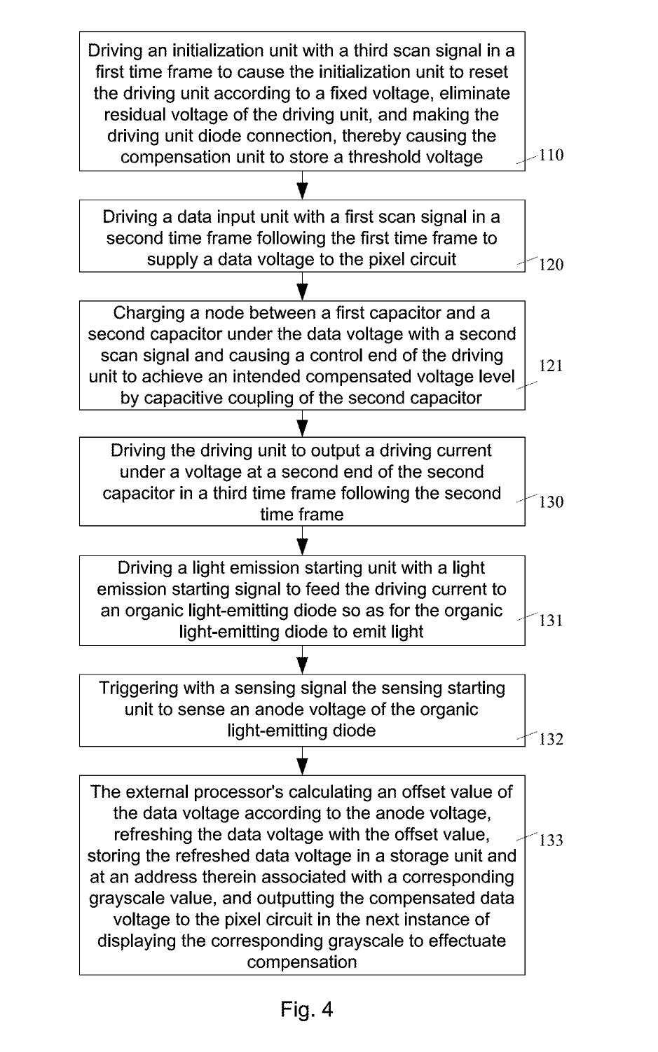

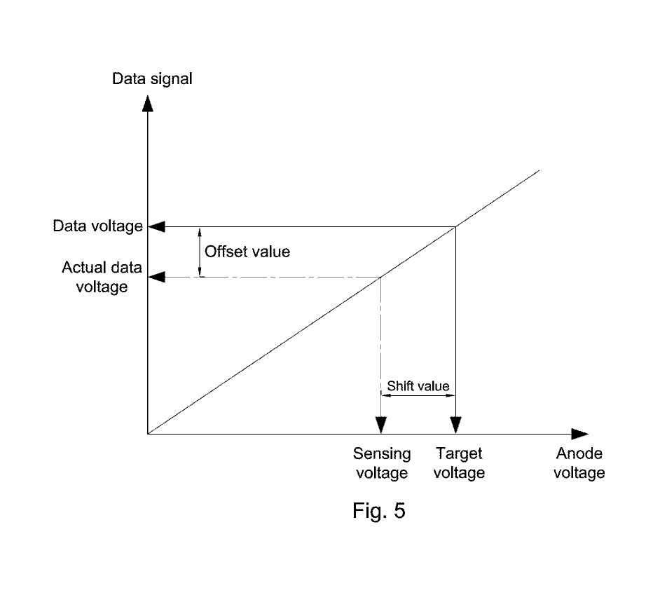

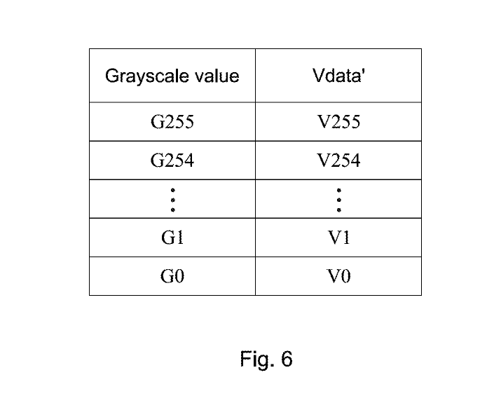

Referring to FIG. 4, FIG. 5 and FIG. 6, there are shown a schematic view of the process flow of a driving method, a schematic view of a look-up table of “anode voltage-data voltage” relationship demonstrated by an external compensation computational unit, and a schematic view of how compensated data voltages correlate with grayscale values in a storage unit, of the active-matrix organic light-emitting diode pixel circuit of an integrated external processor according to the preferred embodiment of the present invention. In the preferred embodiment of the present invention, the driving method is adapted for use in driving the active-matrix organic light-emitting diode pixel circuit 1 of an integrated external processor. The driving method comprises the steps as follows:

Step 110: driving the initialization unit 15 with a third scan signal Sw3 in a first period S1 to cause the initialization unit 15 to reset the driving unit 12 according to a fixed voltage Vint, eliminate residual voltage of the driving unit 12, and making the driving unit 12 diode connection, thereby causing the compensation unit 14 to store a threshold voltage. The first period S1 is an initial stage. In the first period S1, the initialization unit 15 charges the gate of the driving unit 12 under the fixed voltage Vint so as to effectuate reset (as described below by using the first transistor T1 as the driving unit) and eliminate residual voltage left behind during the preceding operation period such that the voltage level in a subsequent, new driving period is more accurate. At this point in time, with the fifth transistor T5 being turned on, a short circuit is created between the gate and the drain of the first transistor T1; hence, the first transistor T1 forms diode connection and thus turns on. Given the fixed voltage Vint level at the gate of the first transistor T1, there is a voltage difference, i.e., a threshold voltage Vth level, between the source and the gate of the first transistor T1, and the source develops a (Vint+Vth) level. At this point in time, the second capacitor C2 stores the threshold voltage Vth.

Step 120: driving the data input unit 13 with a first scan signal Sw1 in a second period S2 following the first period 51 to supply a data voltage Vdata to the pixel circuit.

Step 121: charging a node between the first capacitor C1 and the second capacitor C2 under the data voltage Vdata with a second scan signal Sw2 and causing the control end T1c of the driving unit 12 to achieve an intended compensated voltage level by capacitive coupling of the second capacitor C2. The second period S2 is a compensation stage. The second period S2 involves inputting the data voltage Vdata to a node between the first capacitor C1 and the second capacitor C2 and causing the gate of the first transistor T1 to achieve an intended compensated voltage (Vdata−Vth) level by capacitive coupling of the second capacitor C2. At this point in time, the gate of the first transistor T1 stores variation in the threshold voltage Vth, so as to effectuate compensation.

Step 130: driving the driving unit 12 to output a driving current Id under a voltage at a second end of the second capacitor C2 in a third period S3 following the second period S2.

Step 131: driving the light emission starting unit 11 with a light emission starting signal to feed the driving current Id to the OLED so as for the OLED to emit light. The third period S3 is an emission stage. In the third period S3, the second reference voltage ELVDD passes through the first transistor T1 to turn on the OLED so as for the OLED to emit light.

Step 132: triggering with a sensing signal Sen the sensing starting unit 16 to sense an anode voltage of the OLED. At this point in time, as soon as the eighth transistor T8 receives the sensing signal Sen and thus turns on, the sensing starting unit 16 starts sensing the anode voltage of the OLED, and buffers in the external processor 2 transmit the sensed anode voltage to the external compensation computational unit 22 without affecting the driving current, so as to effectuate compensation computation and preclude anode voltage changes which might otherwise arise in the course of sensing and transmission to the detriment of the driving current Id passing through the OLED.

Step 133: the external processor 2 calculates an offset value of the data voltage Vdata according to the anode voltage, refreshes the data voltage Vdata with the offset value, stores the refreshed data voltage Vdata′ in the storage unit and at an address therein associated with a corresponding grayscale value, and outputs the compensated data voltage Vdata′ to the pixel circuit 1 in the next instance of displaying the corresponding grayscale so as to effectuate compensation. Referring to FIG. 5, in the preferred embodiment of the present invention, the principle of compensation computation is as follows: effectuating judgment and computation with a look-up table configured in the external processor 2 and related to the relationship of anode voltage and data voltage, inferring an actual data voltage from a sensing voltage according to a relationship diagram, and calculating the difference between the original data voltage Vdata and the actual data voltage, wherein the calculated difference is regarded as an offset value. Afterward, the offset value is added to the original data voltage Vdata to obtain the compensated data voltage Vdata′. Then, the compensated data voltage Vdata′ is stored in the storage unit 23 and at an address therein associated with a corresponding grayscale value (i.e., the addresses of the compensated data voltage and 8-bit grayscale, as shown in FIG. 6). The compensated data voltage Vdata′ corresponding to the grayscale is input to the pixel circuit 1 in the next instance of displaying the same grayscale, so as to compensate for the threshold voltage drift of the first transistor T1 and degradation of the OLED.

Referring to the accompanying drawings, in a preferred embodiment of the present invention, an active-matrix organic light-emitting diode pixel circuit of an integrated external processor and a driving method for the same are provided. The active-matrix organic light-emitting diode pixel circuit of an integrated external processor comprises eight transistors, two capacitors, a driving unit, a sensing starting unit, and an external compensation computational unit. In an initialization stage, the gate of the driving unit 12 is charged under a fixed voltage Vint. Residual voltage that remains at the gate of the driving unit 12 during the preceding driving period is eliminated such that a required voltage level is accurately achieved in a subsequent, new driving period. The pixel circuit not only compensates for a threshold voltage, but also has two advantages (compensation for variation in the threshold voltage cannot be fully achieved, because of a transistor's process and driving) as follows: the sensing starting unit 16 senses the anode voltage of the OLED in an emission stage; and the external compensation computational unit 22 effectuates anode voltage compensation. Therefore, the present invention reduces mura which might otherwise arise from variation in the threshold voltage and degradation of the OLED.

The above detailed description sufficiently shows that the present invention has non-obviousness and novelty and thus meets patentability requirements. However, the aforesaid preferred embodiments are illustrative of the present invention only, but should not be interpreted as restrictive of the scope of the present invention. Hence, all equivalent changes and modifications made to the aforesaid embodiments should fall within the scope of the claims of the present invention.

What is claimed is:

1. An active-matrix organic light-emitting diode pixel circuit of an integrated external processor, comprising:
an organic light-emitting diode coupled to a first reference voltage to receive a driving current so as to emit light;
a first capacitor having a first end and a second end, with the first end coupled to a second reference voltage;
a light emission starting unit coupled to the organic light-emitting diode, the first end of the first capacitor, and the second reference voltage to cause the driving current to go to the organic light-emitting diode according to a light emission starting signal;
a driving unit coupled to the light emission starting unit to generate and output the driving current, wherein the driving unit has a first end, a second end, and a control end;
a data input unit coupled to the first end of the driving unit and the light emission starting unit to supply a data voltage according to a first scan signal;
a compensation unit coupled to the second end of the first capacitor, the first end and the control end of the driving unit, the light emission starting unit, and the data input unit to compensate for a threshold voltage of the driving unit according to a second scan signal and the data voltage;
an initialization unit coupled to the control end and the second end of the driving unit and the compensation unit to reset the driving unit according to a fixed voltage and a third scan signal and cause the compensation unit to store the threshold voltage; and
a sensing starting unit coupled to the organic light-emitting diode and an external processor to sense an anode voltage of the organic light-emitting diode according to a sensing signal, transmit the anode voltage to an external processor, cause the external processor to calculate an offset value of the data voltage according to the anode voltage, and refresh the data voltage with the offset value.

2. The active-matrix organic light-emitting diode pixel circuit of an integrated external processor according to claim 1, wherein the external processor comprises:
a voltage sensing unit in telecommunication with the sensing starting unit to transmit the anode voltage without affecting light emission function of the light-emitting diode;
an external compensation computational unit in telecommunication with the voltage sensing unit to calculate the offset value according to the anode voltage and refresh the data voltage with the offset value; and
a storage unit in telecommunication with the external compensation computational unit and the data input unit to store the compensated data voltage at an address associated with a corresponding grayscale value and output the compensated data voltage to the data input unit in a next instance of displaying the corresponding grayscale.

3. The active-matrix organic light-emitting diode pixel circuit of an integrated external processor according to claim 1, wherein the driving unit comprises a first transistor, the first transistor having:
a first end coupled to the light emission starting unit, the data input unit, and the compensation unit;
a second end coupled to the light emission starting unit and the initialization unit and generating the driving current such that the driving current passes through the light emission starting unit and reaches the organic light-emitting diode; and
a control end coupled to the compensation unit and the initialization unit.

4. The active-matrix organic light-emitting diode pixel circuit of an integrated external processor according to claim 1, wherein the compensation unit comprises a second capacitor and a second transistor, the second capacitor having an end coupled to the second end of the first capacitor and having another end coupled to the control end of the driving unit and the initialization unit, and the second transistor having:
a first end coupled to the second end of the first capacitor;
a second end coupled to the first end of the driving unit, the light emission starting unit, and the data input unit; and
a control end for receiving the second scan signal.

5. The active-matrix organic light-emitting diode pixel circuit of an integrated external processor according to claim 1, wherein the data input unit comprises a third transistor, the third transistor having:
a first end coupled to the first end of the driving unit, the light emission starting unit, and the compensation unit to output the data voltage;
a second end coupled to the external processor to receive the data voltage; and
a control end for receiving the first scan signal.

6. The active-matrix organic light-emitting diode pixel circuit of an integrated external processor according to claim 1, wherein the initialization unit comprises a fourth transistor and a fifth transistor, the fourth transistor having:
a first end for receiving the fixed voltage;
a second end coupled to the compensation unit, the control end of the driving unit, and the fifth transistor; and
a control end for receiving the third scan signal;
the fifth transistor having:
a first end coupled to the second end of the fourth transistor, the compensation unit, and the control end of the driving unit;
a second end coupled to the light emission starting unit and the second end of the driving unit; and
a control end for receiving the third scan signal.

7. The active-matrix organic light-emitting diode pixel circuit of an integrated external processor according to claim 1, wherein the light emission starting unit comprises a sixth transistor and a seventh transistor,
the sixth transistor having:
a first end coupled to the organic light-emitting diode and the sensing starting unit;
a second end coupled to the initialization unit and the second end of the driving unit; and
a control end for receiving the light emission starting signal;
the seventh transistor having:
a first end coupled to the compensation unit, the data input unit, and the first end of the driving unit;
a second end coupled to the first end of the first capacitor and the second reference voltage; and
a control end for receiving the light emission starting signal.

8. The active-matrix organic light-emitting diode pixel circuit of an integrated external processor according to claim 1, wherein the sensing starting unit comprises an eighth transistor, the eighth transistor having:
a first end coupled to the organic light-emitting diode and the light emission starting unit;
a second end coupled to the external processor; and
a control end for receiving the sensing signal.

9. A driving method for an active-matrix organic light-emitting diode pixel circuit of an integrated external processor, adapted to drive the active-matrix organic light-emitting diode pixel circuit of an integrated external processor of claim 1, the driving method comprising the steps of:
a. driving the initialization unit with the third scan signal in a first period to cause the initialization unit to reset the driving unit according to the fixed voltage, eliminate residual voltage of the driving unit, and making the driving unit diode connection, thereby causing the compensation unit to store a threshold voltage;
b. driving the data input unit with the first scan signal in a second period following the first period to supply a data voltage to the pixel circuit, charging a node between the first capacitor and the compensation unit under the data voltage with the second scan signal and causing the control end of the driving unit to achieve an intended compensated voltage level by the compensation unit; and
c. driving the driving unit to output the driving current under a voltage at a second end of the second capacitor in a third period following the second period, driving the light emission starting unit with the light emission starting signal to feed the driving current to the organic light-emitting diode so as for the organic light-emitting diode to emit light, triggering with the sensing signal the sensing starting unit to sense an anode voltage of the organic light-emitting diode, transmitting a sensing voltage to the external processor without affecting the driving current, and allowing the external processor to calculate an offset value of the data voltage according to the anode voltage, refresh the data voltage with the offset value, store the refreshed data voltage in the storage unit and at an address therein associated with a corresponding grayscale value, and output the compensated data voltage to the pixel circuit in the next instance of displaying the corresponding grayscale to effectuate compensation.

10. The driving method for an active-matrix organic light-emitting diode pixel circuit of an integrated external processor according to claim 9, wherein, in the step b, the compensation unit further comprises a second capacitor and a second transistor, and the step b further comprises charging a node between the first capacitor and the second capacitor under the data voltage and causing the control end of the driving unit to achieve an intended compensated voltage level by capacitive coupling of the second capacitor.
